(19) United States
(12) Patent Application Publication
(10) Pub. No.: US 2019/0007966 A1
(43) Pub. Date: Jan. 3, 2019

(54) APPARATUS, SYSTEM, AND METHOD OF DETERMINING ONE OR MORE CHANNEL ACCESS PARAMETERS FOR WIRELESS COMMUNICATION

(71) Applicant: INTEL IP CORPORATION, SANTA CLARA, CA (US)

(72) Inventors: Laurent Cariou, Portland, OR (US); Bahareh Sadeghi, Portland, OR (US); Cheng Chen, Hillsboro, OR (US)

(21) Appl. No.: 15/637,123

(22) Filed: Jun. 29, 2017

(51) Int. Cl. H04W 74/00

(52) U.S. Cl. CPC H04W 74/006; H04W 74/08

(57) ABSTRACT

For example, a wireless communication station may be configured to communicate over a wireless channel with a plurality of first wireless communication stations via a plurality of wireless communication links, the plurality of wireless communication links including at least one backhaul link with a relay station of the plurality of first wireless communication stations, the backhaul link to communicate between the wireless communication station and one or more second wireless communication stations via the relay station; to determine, based on a count of the one or more second wireless communication stations, one or more channel access parameters corresponding to at least one wireless communication link of the plurality of wireless communication links; and to communicate over the wireless communication link according to the one or more channel access parameters.

### TECHNICAL FIELD

Embodiments described herein generally relate to determining one or more channel access parameters for wireless communication.

### BACKGROUND

A relay station may connect one or more wireless communication stations to an AP via a backhaul link. For example, the backhaul link may be utilized to communicate between the AP and the one or more wireless communication stations via the relay station.

The AP and the relay station may be required to access a wireless channel according to one or more channel access mechanisms in order to communicate over the backhaul link.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of a network deployment to illustrate a technical problem, which may be solved in accordance with some demonstrative embodiments.

FIG. 3 is a schematic illustration of an airtime access scheme, in accordance with some demonstrative embodiments.

FIG. 4 is a schematic illustration of an airtime access scheme, in accordance with some demonstrative embodiments.

FIG. 5 is a schematic flow-chart illustration of a method of determining one or more channel access parameters, in accordance with some demonstrative embodiments.

FIG. 6 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, an Internet of Things (IoT) device, a sensor device, a wearable device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing IEEE 802.11 standards (including IEEE 802.11-2016 (IEEE 802.11-2016, IEEE Standard for Information technology—Telecommunications and information exchange between systems Local and metropolitan area networks—Specific requirements, Part 11: Wireless IAN Medium Access Control (MAC) and Physical Layer (PHY) Specifications, Dec. 7, 2016) and/or IEEE 802.11ax (IEEE 802.11ax, High Efficiency WLAN (HEW)); future versions and/or derivatives thereof, devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing WiFi Alliance (WFA) Peer-to-Peer (P2P) specifications (WiFi P2P technical specification, version 1.5, August 2014) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments may be used in conjunction with a WLAN, e.g., a WiFi network. Other embodiments may be used in conjunction with any other suitable wireless communication network, for example, a wireless area network, a “piconet”, a WPAN, a WVAN and the like.

Some demonstrative embodiments may be used in conjunction with a wireless communication network communicating over a frequency band of 2.4 or 5 Gigahertz (GHz). However, other embodiments may be implemented utilizing any other suitable wireless communication frequency bands, for example, a 60 GHz band, a millimeterWave (mmWave) frequency band, a Sub 1 GHz (S1G) frequency band, a WLAN frequency band, a WPAN frequency band, and the like.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

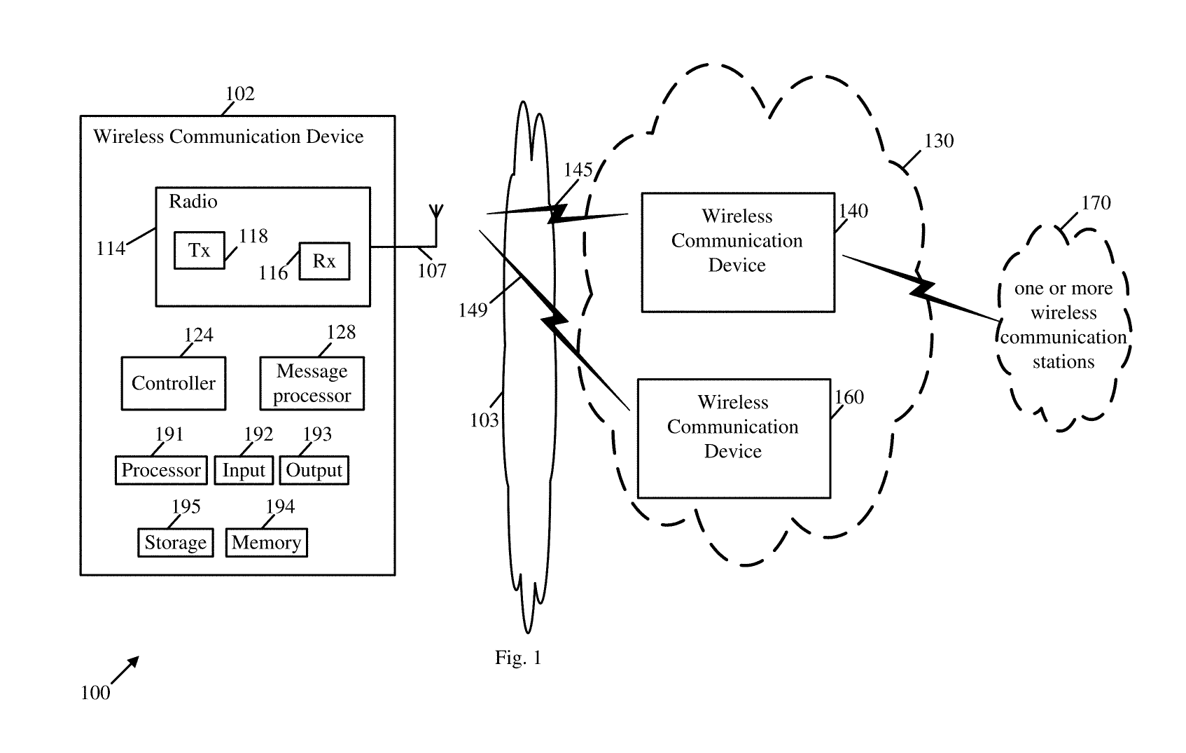

Reference is made to FIG. 1, which schematically illustrates a system 100, in accordance with some demonstrative embodiments.

As shown in FIG. 1, in some demonstrative embodiments, system 100 may include one or more wireless communication devices. For example, system 100 may include at least a wireless communication device 102, a plurality of first wireless communication devices 130, and one or more second wireless communication devices 170.

In some demonstrative embodiments, the plurality of first wireless communication devices 130 may include, for example, a wireless communication device 140, a wireless communication device 160, and/or one or more other wireless communication devices.

In some demonstrative embodiments, device 102 may include a mobile device or a non-mobile, e.g., a static, device.

For example, device 102 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative embodiments, device 102 may include, for example, one or more of a processor 191, an input unit 192, an output unit 193, a memory unit 194, and/or a storage unit 195. Device 102 may optionally include other suitable hardware components and/or software components. In some demonstrative embodiments, some or all of the components of one or more of device 102 may be enclosed in a common housing or packaging, and may be interconnected or operably associated using one or more wired or wireless links. In other embodiments, components of one or more of device 102 may be distributed among multiple or separate devices.

In some demonstrative embodiments, processor 191 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications.

In some demonstrative embodiments, input unit 192 may include, for example, a keyboard, a keypad, a mouse, a touch-screen, a touch-pad, a track-ball, a stylus, a microphone, or other suitable pointing device or input device. Output unit 193 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative embodiments, memory unit 194 may include, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 184 and/or storage unit 185, for example, may store data processed by device 140.

In some demonstrative embodiments, wireless communication devices 102, 130 and/or 170 may include, operate as, perform a role of, and/or perform one or more functionalities of, one or more STAs. For example, device 102 may include at least one STA, the plurality of first devices 130 may include a plurality of first stations, and/or the one or more second devices 170 may include one or more second stations.

In one example, a station (STA) may include a logical entity that is a singly addressable instance of a medium access control (MAC) and physical layer (PHY) interface to the wireless medium (WM). The STA may perform any other additional or alternative functionality.

In some demonstrative embodiments, device 102 may include an Access point (AP) STA.

In other embodiments, device 102 may include a non-AP STA.

In one example, an AP STA may include an entity that contains a station (STA), e.g., one STA, and provides access to distribution services, via the wireless medium (WM) for associated STAs. The AP may perform any other additional or alternative functionality.

In one example, a non-access-point (non-AP) station (STA) may include a STA that is not contained within an AP. The non-AP STA may perform any other additional or alternative functionality.

In other embodiments, device 102 may operate as, perform a role of, and/or perform one or more functionalities of, any other additional or alternative device and/or station.

In other embodiments, device 102 may include, operate as, perform a role of, and/or perform one or more functionalities of, any wireless device and/or station, e.g., a WLAN STA, a WiFi STA, and the like.

In some demonstrative embodiments, wireless communication devices 102, 130 and/or 170 may be capable of communicating content, data, information and/or signals via a wireless medium (WM) 103. In some demonstrative embodiments, wireless medium 103 may include, for example, a radio channel, a cellular channel, an RF channel, a WiFi channel, an IR channel, a Bluetooth (BT) channel, a Global Navigation Satellite System (GNSS) Channel, and the like.

In some demonstrative embodiments, devices 102, 130 and/or 170 may include one or more radios including circuitry and/or logic to perform wireless communication between devices 102, 130, 170 and/or one or more other wireless communication devices. For example, device 102 may include at least one radio 114.

In some demonstrative embodiments, radio 114 may include one or more wireless receivers (Rx) including circuitry and/or logic to receive wireless communication signals, RF signals, frames, blocks, transmission streams, packets, messages, data items, and/or data. For example, radio 114 may include at least one receiver 116.

In some demonstrative embodiments, radio 114 may include one or more wireless transmitters (Tx) including circuitry and/or logic to transmit wireless communication signals, RF signals, frames, blocks, transmission streams, packets, messages, data items, and/or data. For example, radio 114 may include at least one transmitter 118.

In some demonstrative embodiments, radio 114, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radio 114 may include or may be implemented as part of a wireless Network Interface Card (NIC), and the like.

In some demonstrative embodiments, radio 114 may be configured to communicate over a directional band, for example, an mmWave band, a 2.4 GHz band, a 5 GHz band, a S1G band, and/or any other band.

In some demonstrative embodiments, radio 114 may include, or may be associated with one or more antennas.

In one example, device 102 may include a single antenna 107. In another example, device 102 may include two or more antennas 107.

In some demonstrative embodiments, antennas 107 may include any type of antennas suitable for transmitting and/or receiving wireless communication signals, blocks, frames, transmission streams, packets, messages and/or data. For example, antennas 107 may include any suitable configuration, structure and/or arrangement of one or more antenna elements, components, units, assemblies and/or arrays. Antennas 107 may include, for example, antennas suitable for directional communication, e.g., using beamforming techniques. For example, antennas 107 may include a phased array antenna, a multiple element antenna, a set of switched beam antennas, and/or the like. In some embodiments, antennas 107 may implement transmit and receive functionalities using separate transmit and receive antenna elements. In some embodiments, antennas 107 may implement transmit and receive functionalities using common and/or integrated transmit/receive elements.

In some demonstrative embodiments, device 102 may include a controller 124. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between device 102 and devices 130,170 and/or one or more other devices, e.g., as described below.

In some demonstrative embodiments, controller 124 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controller 124, respectively. Additionally or alternatively, one or more functionalities of controller 124 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein.

In some demonstrative embodiments, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In some demonstrative embodiments, message processor 128 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, BB circuitry and/or logic, a BB processor, a BB memory, AP circuitry and/or logic, an AP processor, an AP memory, and/or any other circuitry and/or logic, configured to perform the functionality of message processor 128, respectively. Additionally or alternatively, one or more functionalities of message processor 128 may be implemented by logic, which may be executed by a machine and/or one or more processors, e.g., as described below.

In some demonstrative embodiments, at least part of the functionality of message processor 128 may be implemented as part of radio 114.

In some demonstrative embodiments, at least part of the functionality of message processor 128 may be implemented as part of controller 124.

In other embodiments, the functionality of message processor 128 may be implemented as part of any other element of device 102.

In some demonstrative embodiments, at least part of the functionality of controller 124 and/or message processor 128 may be implemented by an integrated circuit, for example, a chip, e.g., a System on Chip (SoC). In one example, the chip or SoC may be configured to perform one or more functionalities of radio 114. For example, the chip or SoC may include one or more elements of controller 124, one or more elements of message processor 128, and/or one or more elements of radio 114. In one example, controller 124, message processor 128, and radio 114 may be implemented as part of the chip or SoC.

In other embodiments, controller 124, message processor 128 and/or radio 114 may be implemented by one or more additional or alternative elements of device 102.

In some demonstrative embodiments, system 100 may include a self-organizing network, e.g., as described below.

In some demonstrative embodiments, system 100 may include, for example, at least one AP and/or controller AP, e.g., a plurality of APs and/or controller APs, and/or at least one relay station (also referred to as “range extender”, e.g., an INTEL Range Extender (IRE)) and/or controlee AP, e.g., a plurality of relay stations and/or controlee APs.

In one example, a relay station, e.g., an IRE or a controlee AP, may be associated with one or more wireless communication stations.

In some demonstrative embodiments, a performance of system 100 may be improved, for example, by enabling coordination between the plurality of APs and/or the plurality of relay stations.

In some demonstrative embodiments, the coordination may be decentralized or centralized. In one example, according to a centralized approach, decisions may be taken at a local controller, which may be in a gateway, e.g., local to the deployment, or in a remote controller, e.g., a web cloud, a remote server and/or the like.

In some demonstrative embodiments, a controller, e.g., a local controller or a remote controller, may collect information from the relay stations and may send commands to the relay stations, for example, to tune one or more parameters with respect to the relay stations and/or or to perform one or more management actions with respect to one or STAs associated with the relay stations.

In some demonstrative embodiments, one or more deployments of system 100 may include, for example, at least two layers of relay stations. For example, a deployment may include a first layer including a first relay station, denoted IRE1, to which one or more first STAs may associate, for example, wherein the one or more first STAs may include a second relay station, denoted IRE2. The second relay station may provide a second layer to which one or more second STAs may be associated, e.g., as described below.

In one example, system 100 may include a deployment, in which device 102 may include the first relay station IRE1, with which devices 130 may be associated. For example, at least one device of devices 130, e.g., device 140, may include the second relay station IRE2, to which one or more devices 170 may associate.

In some demonstrative embodiments, the second relay station IRE2 may be connected to a distributed system (DS), for example, via a backhaul link between the first and second relay stations, e.g., to enable the second STAs to connect to DS, e.g., as described below. In some cases, the second relay station IRE2 may be connected to the DS only via the backhaul link.

Some demonstrative embodiments are described herein with respect to deployments including two layers of relay stations. However, the embodiments described herein are not limited to these exemplary deployments, and, may be expanded and equally applicable to multi-layer topologies, e.g., including more than two layers of relay stations, e.g., three layers or more.

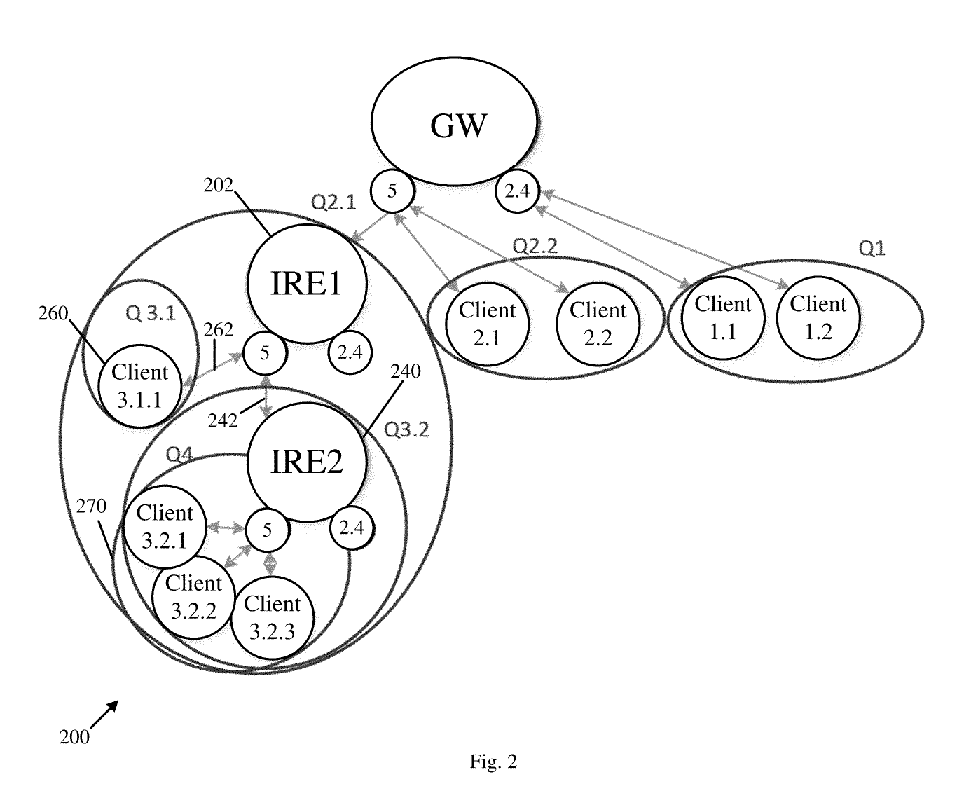

Reference is made to FIG. 2, which schematically illustrates a network deployment 200 to illustrate a technical problem, which may be solved in accordance with some demonstrative embodiments.

In some demonstrative embodiments, as shown in FIG. 2, network 200 may include two-layer network.

In some demonstrative embodiments, as shown in FIG. 2, a first relay station 202, denoted IRE1, may be associated with a plurality of first STAs, for example, via a plurality of wireless communication links, e.g., as described below.

In some demonstrative embodiments, as shown in FIG. 2, the first relay station 202 may be associated with at least one STA 260.

In some demonstrative embodiments, as shown in FIG. 2, first relay station 202 may be associated with a second relay STA 240, denoted IRE2.

In some demonstrative embodiments, as shown in FIG. 2, second relay STA 240 may be associated with a plurality of second STAs 270, e.g., including three wireless communication stations, or any other number of stations.

In some demonstrative embodiments, as shown in FIG. 2, second relay station 240 may communicate with first relay station 202 over a backhaul link 242.

In some demonstrative embodiments, as shown in FIG. 2, first relay station 202 may communicate with the at least one STA 260 via at least one respective wireless communication link 262.

In one example, a general mesh, e.g., network 200, may be deployed using a layer three (L3) relay scheme. According to this example, packets from clients associated with relay station 240, e.g., the plurality of STAs 270, may be routed in L3, e.g., from relay station 202 to relay station 240. For example, a MAC layer of relay station 202 may identify only a MAC address of relay station 240 for all downlink traffic for the plurality of STAs 270.

In one example, device 102 (FIG. 1) may be configured to operate as, perform a role of, and/or perform one or more operations and/or functionalities of, STA 202; device 160 (FIG. 1) may be configured to operate as, perform a role of, and/or perform one or more operations and/or functionalities of, STA 260; device 140 (FIG. 1) may be configured to operate as, perform a role of, and/or perform one or more operations and/or functionalities of, STA 240; and/or devices 170 (FIG. 1) may be configured to operate as, perform a role of, and/or perform one or more operations and/or functionalities of, STAs 270.

In some demonstrative embodiments, there may be a technical need to ensure fairness in channel access, e.g., for the backhaul link 242 and wireless link 262, for example, if backhaul link 242 and wireless communication link 262 utilize the same medium resources, e.g., a same band and/or a same channel.

For example, as shown in FIG. 2, wireless link 262 may serve only one STA, e.g., STA 260, while backhaul link 242 may serve three STA, e.g., the plurality of STAs 270, and the backhaul link 242 to/from relay station 202. Therefore, backhaul link 242 may require, for example, a link capacity of three STAs.

In some demonstrative embodiments, fair channel access may not be ensured, for example, in case that relay station 202 is not aware that relay station 240 serves three STAs, and, accordingly, relay station 202 treats relay station 240 as a single STA. In such a case, for example, relay station 202 may only be aware of only two STA, e.g., STA 260 and relay station 240.

For example, if relay station 202 treats relay station 202 as a single STA for channel access, relay station 202 may allocate the same share of communication resources to STA 260 and relay station 240, e.g., by allocating each 50% of an airtime access, for example, based on one or more channel access rules. As a result, the three STAs 270 may share 50% of airtime access and, as a result may receive less capacity, e.g., compared to the capacity of STA 260. Such an allocation of the channel access may result in a bottleneck for STAs 270 and/or may not ensure fairness in channel access for STAs 270.

Referring back to FIG. 1, in some demonstrative embodiments a wireless communication station, e.g., a station implemented by device 102, may be configured to ensure an airtime fairness in channel access of a plurality of wireless communication links, to and/or from the wireless station, e.g., as described below. For example, device 102 may be configured to ensure airtime fairness in channel access between backhaul link 242 and wireless links 262 (FIG. 2).

In some demonstrative embodiments, device 102 may be configured to support one or more fairness parameters or metrics, which may be configured to allow airtime fairness between a plurality of STA, for example, STAs 130, e.g., as described below.

In some demonstrative embodiments, device 102 may communicate with the plurality of first wireless communication stations, e.g., including devices 140 and 160, via a plurality of wireless communication links over a wireless channel.

In some demonstrative embodiments, controller 124 may be configured to control, cause and/or trigger device 102 to communicate with the plurality of first wireless communication stations 130 via a plurality of wireless communication links over the wireless channel, e.g. as described below.

In some demonstrative embodiments, the plurality of first wireless communication stations 130 may include a relay station, e.g., device 140, which may be associated with the one or more second wireless communication stations 170.

In some demonstrative embodiments, the plurality of wireless communication links between device 102 and stations 130 may include at least one backhaul link 145 with a relay station, e.g., device 140, of the plurality of first wireless communication stations 130. For example, the backhaul link 145 may connect between devices 102 and 140.

In some demonstrative embodiments, the plurality of wireless communication links between device 102 and stations 130 may include at least one other link 149 with at least one other station, e.g., device 160.

In some demonstrative embodiments, device 102 may communicate with the one or more second wireless communication stations 170, e.g., via the backhaul link 145 between device 102 and device 140.

In some demonstrative embodiments, device 102 may be configured to implement a fairness mechanism, e.g., a flexible fairness mechanism, which may utilize one or more types of fairness metrics, for example, to allocate channel access resources to the links between device 102 and devices 103, e.g., as described below.

In some demonstrative embodiments, the fairness mechanism may be implemented base don one or more principles, operations, and/or rules, e.g., as described below.

In some demonstrative embodiments, device 102 may be configured to enable a MAC layer of a STA, e.g., an IRE, implemented by device 102 to receive information corresponding to a number of STAs that are using a backhaul UL/DL link from/to a relay station, e.g., device 140, and/or any other information and/or statistics. For example, the MAC layer of device 102, e.g., a MAC controller implemented by controller 124, may receive information corresponding to a number of a wireless communication stations, e.g., a number of stations 170, which may be associated with device 140 and may using the backhaul link 145 between device 140 and device 102, e.g., as described below.

In some demonstrative embodiments, one or more modifications of a MAC layer, e.g., a MAC scheduler and/or an Enhanced Distributed Channel Access (EDCA) function of device 102, may be applied, for example, to enable DL and/or UL fairness mechanisms for DL and/or UL airtime access, e.g., as described below.

In some demonstrative embodiments, the one or more modifications of the MAC layer may be applied, for example, for DL fairness mechanisms for DL airtime access, e.g., as described below.

In some demonstrative embodiments, device 102 may be configured to use different EDCA parameters, for example, to enable the DL fairness mechanisms, for example, a minimum Contention window (CWmin) parameter, a maximum Contention window (CWmax) parameter, an Arbitration Inter-Frame Spacing Number (AIFSN) parameter, and/or a transmission opportunity (TxOP) parameter, for STAs that are associated to device 102, and for relay stations that relay traffic to device 102 from STAs associated with the relay stations. For example, device 102 may be configured to use a first EDCA parameter for device 140 and/or a second, e.g., different, EDCA parameter for device 160, for example, to support the DL fairness mechanisms, e.g., as described below.

In some demonstrative embodiments, device 102 may be configured to provide DL channel access to a relay station, e.g., device 140, which is proportional to the number of STAs, e.g., stations 170, that use a backhaul link, e.g., backhaul link 145, from the relay station to device 102, e.g., as described below.

In some demonstrative embodiments, the EDCA parameters for DL channel access may be modified, e.g., dynamically, for example, based on a long-term basis or a packet-per-packet basis, e.g., as described below.

In some demonstrative embodiments, the modifications may be internal to the MAC layer of device 102, e.g., as described below.

In some demonstrative embodiments, the one or more modifications of the MAC layer, e.g., the MAC scheduler and/or the EDCA function of device 102, may be applied, for example, to enable UL fairness mechanisms for UL airtime access, e.g., as described below.

In some demonstrative embodiments, device 102 may be configured to use different EDCA parameters, for example, to support the UL fairness mechanisms, e.g., a CWmin parameter, a CWmax parameter, an AIFSN parameter, and/or a TxOP parameter, for STAs that are associated to device 102, and for relay stations that relay traffic to device 102 from STAs associated with the relay stations. For example, device 102 may be configured to use a first EDCA parameter for device 140, and/or a second, e.g., different, EDCA parameter for device 160, for example, to support the UL fairness mechanisms, e.g., as described below.

In some demonstrative embodiments, device 102 may be configured to provide UL channel access to a relay station, e.g., device 140, which is proportional to the number of STAs, e.g., stations 170, that use a backhaul, e.g., backhaul link 145, from the relay station to device 102, e.g., as described below.

In some demonstrative embodiments, the EDCA parameters for UL channel access may be modified, e.g., dynamically, for example, based on a long-term basis or a packet-per-packet basis, e.g., as described below.

In some demonstrative embodiments, one or more fairness mechanisms may be defined, for example, to support sending one ort more of the EDCA parameters, for example, from a STA, e.g., device 102, to one or more relay stations, e.g., device 130, and/or other stations, e.g., device 160, e.g., as described below.

In some demonstrative embodiments, one or more fairness mechanisms may be utilized to define different channel access parameters for STAs, for example, instead of a configuration in which all STAs use the same EDCA parameters displayed by an AP in an EDCA parameter set element, for example, in beacons transmitted from the AP.

In some demonstrative embodiments, a first fairness mechanism may be defined, for example, to enable device 102 to send different EDCA parameters to a plurality of stations, for example, relay stations and/or other stations, to enable the plurality of stations to receive the EDCA parameters, for example, on a per-packet basis, e.g., using over-the-air control and/or management frames, e.g., as described below.

In some demonstrative embodiments, a second fairness mechanism may be defined, for example, as a proprietary solution, e.g., even without using over-the-air management and/or control frames, in which a coordination may be implemented between two wireless stations, e.g., via L3, and/or one or more ways may be defined for a relay station, for example, to autonomously select EDCA parameters to be used by the relay station, e.g., as described below.

In some demonstrative embodiments, device 102 may be configured to determine one or more channel access parameters, for example, for the plurality of wireless communication links between device 102 and the plurality of first devices 130, e.g., as described below.

In some demonstrative embodiments, controller 124 may be configured to control, cause and/or trigger device 102 to determine one or more channel access parameters corresponding to at least one wireless communication link of the plurality of wireless communication links, for example, based at least on a count of one or more wireless second communication stations, e.g., stations 170, which communicate with device 102 via one or more backhaul links, e.g., link 145, e.g. as described below.

In some demonstrative embodiments, the channel access parameters corresponding to a wireless communication link may be configured to allocate one or more communication resources for communication over the wireless channel via the wireless communication link, e.g. as described below.

In some demonstrative embodiments, the one or more channel access parameters may include one or more EDCA parameters, e.g. as described below.

In some demonstrative embodiments, the one or more channel access parameters may include a minimum Contention window (CWmin) parameter, a maximum Contention window (CWmax) parameter, an Arbitration Inter-Frame Spacing Number (AIFSN) parameter, and/or a transmission opportunity (TxOP), e.g. as described below.

In other embodiments, the one or more channel access parameters may include any other additional or alternative parameters.

In some demonstrative embodiments, the one or more communication resources for communication via the wireless communication link may include one or more time resources, e.g. as described below.

In some demonstrative embodiments, the one or more communication resources for communication via the wireless communication link may include one or more resource unit (RU) allocations in a frequency domain, for example, one or more OFDMA RU allocations, e.g. as described below.

In some demonstrative embodiments, the one or more communication resources for communication via the wireless communication link may include one or more spatial stream allocations in a spatial-domain, e.g. as described below.

In other embodiments, the one or more communication resources for communication via the wireless communication link may include any other additional or alternative type of communication resources.

In some demonstrative embodiments, the backhaul link 145 may include an UL backhaul link, and/or a downlink DL backhaul link, e.g. as described below.

In some demonstrative embodiments, controller 124 may be configured to control, cause and/or trigger device 102 to adjust one or more channel access parameters for communication over one or more wireless communication links between device 102 and devices 130, e.g., backhaul link 145 and/or link 149, for example, based on a change in the count of the one or more second wireless communication stations 170, e.g., as described below.

In some demonstrative embodiments, controller 124 may be configured to control, cause and/or trigger device 102 to receive from device 140 relay information to indicate the count of wireless communication stations 170 to be connected to device 102 via backhaul link 145, e.g., as described below.

In one example, device 140 may be configured to transmit the device 102 the relay information including the count of wireless communication stations 170, e.g., as described below.

In some demonstrative embodiments, controller 124 may be configured to control, cause and/or trigger device 102 to determine a plurality of weight values corresponding to respective ones of the plurality of wireless communication links between device 102 and devices 130, e.g., as described below.

In some demonstrative embodiments, controller 124 may be configured to control, cause and/or trigger device 102 to determine the channel access parameters for a wireless communication link, e.g., backhaul link 145 and/or link 149, for example, based on the plurality of weight values, e.g., as described below.

In some demonstrative embodiments, a weight value corresponding to the backhaul link 145 may be based on the count of the wireless communication stations 170, e.g., as described below.

In some demonstrative embodiments, controller 124 may be configured to control, cause and/or trigger device 102 to determine one or more channel access parameters corresponding to the backhaul link 145, for example, based at least on the count of wireless communication stations 170, e.g., as described below.

In some demonstrative embodiments, controller 124 may be configured to control, cause and/or trigger device 102 to determine one or more channel access parameters corresponding to the link 149, for example, based at least on the count of wireless communication stations 170, e.g., as described below.

In some demonstrative embodiments, controller 124 may be configured to control, cause and/or trigger device 102 to determine the one or more channel access parameters corresponding to the backhaul link 145, for example, based at least on a throughput to be communicated with the wireless communication stations 170 via device 140, e.g., as described below.

In some demonstrative embodiments, controller 124 may be configured to control, cause and/or trigger device 102 to determine the one or more channel access parameters corresponding to the backhaul link 145, for example, based at least on a reference throughput for the wireless communication stations 170 via device 140, e.g., as described below.

In some demonstrative embodiments, the reference throughput corresponding to a station 170 may include, or may be based on, one or more parameters corresponding to a previous or historic throughput of the station 170, e.g., during a previous time window, a long term throughput of the station 170, an average throughput of the station 170, a moving average of the throughput of the station 170, a statistical throughput of the station 170, a preconfigured throughput of the station 170, a threshold throughput of the station 170, and/or any other additional or alternative parameter, e.g., as described below.

In some demonstrative embodiments, controller 124 may be configured to control, cause and/or trigger device 102 to determine the one or more channel access parameters corresponding to a wireless communication link, e.g., backhaul link 145 and/or link 149, for example, based at least on a first value and a second value, e.g., as described below.

In some demonstrative embodiments, the first and second values may be based at least on a station count metric, e.g., as described below.

In some demonstrative embodiments, the first value may be based on at least on a count of stations to be communicated via the wireless communication link, and the second value based at least on a total count of stations to be communicated via the plurality of wireless communication links between device 102 and devices 130.

In some demonstrative embodiments, the first and second values may be based at least on throughput, e.g., as described below.

In some demonstrative embodiments, the first value may be based, for example, on a first throughput to be communicated over the wireless communication link, e.g., as described below.

In some demonstrative embodiments, the second value may be based, for example, on a total throughput to be communicated via the plurality of wireless communication links between device 102 and devices 130, e.g., as described below.

In other embodiments, the first and second values may be based on any other additional or alternative metrics, e.g., as described below.

In some demonstrative embodiments, controller 124 may be configured to control, cause and/or trigger device 102 to determine one or more channel access parameters corresponding to a wireless communication link, e.g., backhaul link 145 and/or link 149, for example, based on a ratio between the first value and the second value, e.g., as described below.

In some demonstrative embodiments, wireless communication stations 170 may include a second relay station associated with one or more third wireless communication stations, e.g., as described below.

In some demonstrative embodiments, the one or more third wireless communication stations may communicate with device 102 via a second backhaul link between the device 140 and the second relay station of stations 170.

In some demonstrative embodiments, controller 124 may be configured to control, cause and/or trigger device 102 to determine the one or more channel access parameters corresponding to the wireless communication link, e.g., backhaul link 145 and/or link 149, for example, based at least on a count of the one or more third wireless communication stations, e.g., as describe below.

In some demonstrative embodiments, controller 124 may be configured to control, cause and/or trigger device 102 to communicate over the wireless communication link, e.g., backhaul link 14 and/or link 149, according to the one or more channel access parameters corresponding to the wireless communication link, e.g., as described below.

In some demonstrative embodiments, a weight value may be defined on a per link basis, for example, for each client of device 102, e.g., for devices 140 and/or 160.

In some demonstrative embodiments, device 102 may be configured to determine a portion of an airtime access for each client, for example, proportionally to the weights assigned to the clients.

In some demonstrative embodiments, a weight, denoted W, for a wireless station, e.g., device 140 and/or device 160, may be determined, e.g., as follows:

$$W = \frac{{( {\sum }_{i = 1}^{N} {T}_{i} )}^{α}}{{( {\sum }_{i = 1}^{N} {R}_{i} )}^{β}} \qquad ( 1 )$$

wherein N denotes a count of STAs associated with the station,
wherein Tᵢ denotes an instantaneous, e.g., short-term, serving rate for an i-th STA associated with the wireless station, wherein i=1 . . . N,
wherein Rᵢ denotes an historic, e.g., long-term, throughput for the i-th STA associated with the wireless station,
and wherein α and β denote first and second fairness parameters, respectively.

For example, the value of N may be three for device 140, e.g., when three wireless stations 170 are connected to device 102 via relay device 140, and/or the value of N may be one for device 160, e.g., when the link between devices 102 and 160 is to support communication only with device 160.

In some demonstrative embodiments, different types of fairness between the client stations, e.g., devices 102 and 140, may be achieved, for example, by using different values for the fairness parameters α and/or β.

In some demonstrative embodiments, according to a first fairness scheme, using the values α=0 and β=1 may allow assigning a same throughput for every client STA, e.g., approximately.

In some demonstrative embodiments, according to a second fairness scheme, using the values α=1 and β=1 may allow applying a proportional fairness between the client stations.

In some demonstrative embodiments, according to a third fairness scheme, using the values α=1 and β=0 may maximize a sum of a throughput for the client stations.

In one example, all stations, e.g., all STAs of network 200 (FIG. 2), may have a same instantaneous serving rate and a same historic throughput, e.g., all stations may have the same values of same Tᵢ and Rᵢ. According to this example, the first fairness scheme may lead to a weight of 0.5 for both IRE2 240 (FIG. 2) and client STA 260 (FIG. 2). As a result, each of IRE2 240 (FIG. 2) and client STA 260 (FIG. 2) may be provided with 50% of the airtime access.

In another example, the third fairness scheme may lead to a weight of 0.75 for IRE2 240 (FIG. 2) and a weight of 0.25 for client STA 260. Accordingly, IRE 240 (FIG. 2) may be provided 75% of the airtime access, and client STA 260 (FIG. 2) may be provided 25% of the airtime access. According to this option, each of the client stations 270 (FIG. 2) may be provided with 25% of airtime access, e.g., 75% of the airtime access divided by the three wireless stations. Therefore, each of the four STAs, e.g., STA 260 and STAs 270 (FIG. 2), may be provided with 25% of the airtime access.

In some demonstrative embodiments, device 102 may communicate downlink traffic to the plurality of wireless communication stations 130, e.g., via the plurality of wireless communications links, e.g., links 149 and backhaul link 145, between device 102 and devices 130, e.g., as described below.

In some demonstrative embodiments, controller 124 may be configured to control, cause and/or trigger device 102 to determine one or more backhaul downlink channel access parameters to allocate one or more communication resources for downlink communication from device 102 to wireless communication stations 170 over the backhaul link 145, e.g., as described below.

In some demonstrative embodiments, controller 124 may be configured to control, cause and/or trigger device 102 to determine the one or more backhaul downlink channel access parameters, for example, based on a total amount of traffic pending transmission to the wireless communication stations 170 over the backhaul link 145, e.g., as described below.

In some demonstrative embodiments, one or more modifications may be applied, e.g., to the MAC scheduler or EDCA function of device 102, for example, to enable DL fairness mechanisms for DL airtime access, e.g., as described below.

In some demonstrative embodiments, device 102 may be configured to configure and/or adapt one or more channel access parameters to configure the airtime access for DL communication from device 102 to device 160,e.g., over link 149, and to device 140, e.g., over link 145, which provides the backhaul link to stations 170, e.g., as described below.

In some demonstrative embodiments, device 102 may be configured to ensure that every STA, e.g., associated with device 102 and/or device 140, may have the same airtime access, e.g., as described below.

In one example, to achieve the same airtime access for every STA, device 102 may take into account a number of STAs that are associated with device 140, e.g., devices that receive traffic via device 140, for example, instead of splitting the airtime access by considering only devices 130, e.g., as described below.

In some demonstrative embodiments, device 102 may implement one or more mechanisms, for example, to ensure the airtime fairness for DL communication, e.g., as described below.

In one example, the one or more fairness mechanisms may use weight values, for example, according to the third fairness scheme, which may result in assigning 25% of the airtime access to each of the wireless stations 170, and 25% of the airtime access to device 160, e.g., as described above.

In another example, the one or more fairness mechanisms may use weight values, for example, according to the first or second fairness schemes described above, and/or any other fairness schemes.

In some demonstrative embodiments, a first fairness mechanism may be implemented in a first scenario, e.g., a full buffer scenario, and/or a scenario having all STAs active, in which substantially the same amount of data may be pending for every STA connected to device 102.

In some demonstrative embodiments, the full buffer scenario may achieve airtime fairness, for example, by a proportional airtime access, which is based on a number of STAs, e.g., as described below.

In some demonstrative embodiments, the airtime access of a station may be based on a ratio between a number of STA associated with the station and a total number of STAs, e.g., as described below.

In some demonstrative embodiments, for example, an airtime access of device 160 may be determined, for example, based on a ratio between a number of STAs to be served by the link between device 102 and STA 160, e.g., 1, and a total number of client STAs to be served by device 102, e.g., 4. According to this example, the airtime access of device 160 may be ¼=25%.

In some demonstrative embodiments, for example, an airtime access of device 140 may determined, for example, based on a ratio between a number of STAs to be served by the link between device 102 and STA 140, e.g., 3, and a total number of client STAs to be served by device 102, e.g., 4. According to this example, the airtime access of device 140 may be ¾=75%.

In one example, the first fairness mechanism may be implemented by a MAC of device 102, e.g., by defining two virtual APs, e.g., one for device 140 and one for device 160, and performing a proportional round-robin scheduling between the two virtual APs, e.g., with proportions of ¼ and ¾, and/or by limiting, e.g., a max throughput, of each virtual AP to reach the proportion.

In other embodiments, the first fairness mechanism may be implemented using any other method and/or any other module of device 102.

In some demonstrative embodiments, a static solution, e.g., which is based only on the number of station, may not be efficient in some use cases and/or scenarios.

In some demonstrative embodiments, the first fairness mechanism may utilize one or more channel access parameters, for example, to achieve a required proportion of airtime fairness.

In some demonstrative embodiments, one or more channel access parameters, e.g., EDCA parameters, may be adjusted, for example, for example, for a user in an AP queue, e.g., for user for which device 102 may have DL traffic, for example, based at least on the traffic pending of the user, e.g., as described below.

In one example, the CWmin, the CWmax, and/or AIFSN may be adjusted, for example to change a probability to access a channel according to the required proportions.

In another example, a TxOP parameter, for example, a TxOP duration of a TxOP, may be adjusted, e.g., by defining a TxOP limit per STA, for example, to change the probability to access a channel, e.g., as described below.

In some demonstrative embodiments, a maximal (max) TxOP limit for a STA may be proportional to a number of STAs associated with the STA, e.g., as described below.

In some demonstrative embodiments, a max TxOP limit representing a single user may be applied, for example, for channel access for DL transmissions from device 102 to device 160TxOP.

In some demonstrative embodiments, a max TxOP limit representing a single user may be applied, for example, for channel access for DL transmissions from device 102 to device 140, for example, when device 140 is to relay the DL traffic to one station 170.

In some demonstrative embodiments, a max TxOP limit representing two users may be applied, for example, for channel access for DL transmissions from device 102 to device 140, for example, when device 140 is to relay the DL traffic to two stations 170. For example, the max TxOP limit representing two users may be longer than the max TxOP limit representing a single user, e.g., the max TxOP limit representing two users may be double the max TxOP limit representing a single user.

In some demonstrative embodiments, a max TxOP limit representing three users may be applied, for example, for channel access for DL transmissions from device 102 to device 140, for example, when device 140 is to relay the DL traffic to three stations 170. For example, the max TxOP limit representing three users may be longer than the max TxOP limit representing two users, e.g., the max TxOP limit representing two users may be three times the max TxOP limit representing a single user.

In some demonstrative embodiments, the max TxOP limit for a single user may be calculated, for example, according to a total number of STAs that device 102 can serve.

In some demonstrative embodiments, if a STA does not have enough throughput, e.g., for the max TxOP limit, the STA may release the TxOP before an end of the TxOP, e.g., as the max TxOP limit defines a maximal duration allowed for the TxOP.

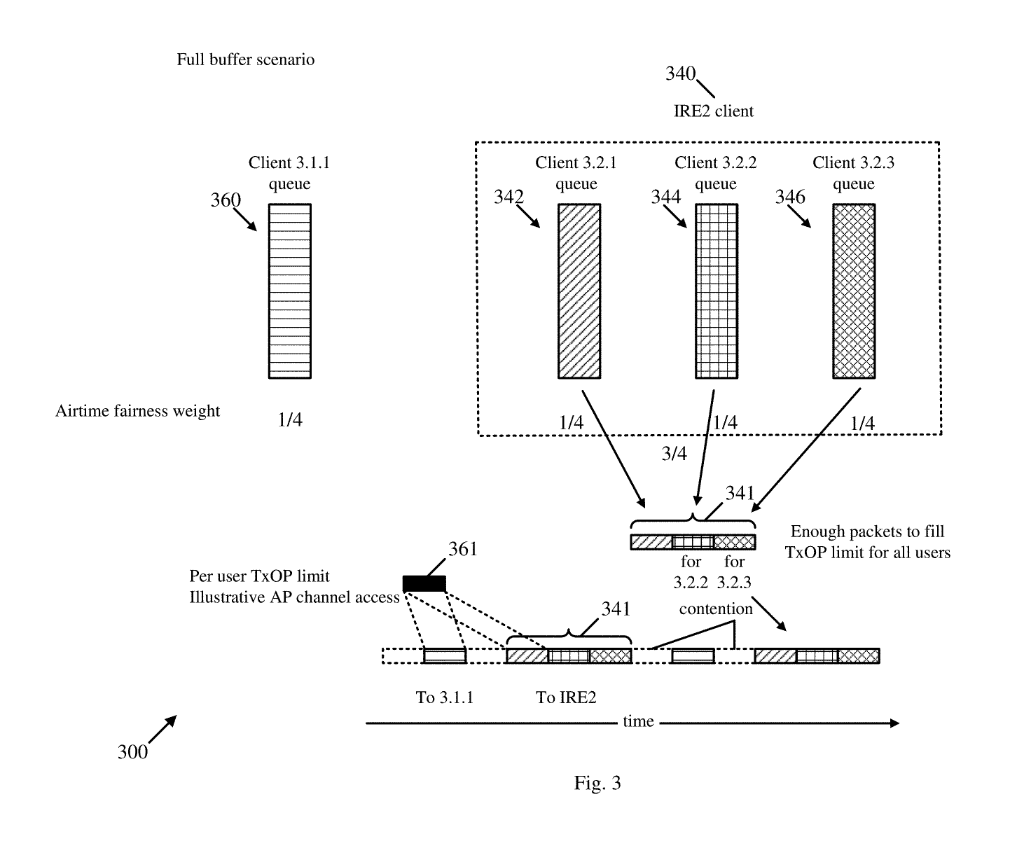

Reference is made to FIG. 3, which schematically illustrates an airtime access scheme 300, in accordance with some demonstrative embodiments.

In some demonstrative embodiments, airtime access scheme 300 may be configured for a full buffer scenario, in which an amount of data pending for every STA is equal, e.g., when all STAs are active.

In some demonstrative embodiments, device 102 (FIG. 1) may allocate one or more communication resources, for example, a TxOP parameter, e.g., a max TxOP limit, to devices 140 and 160 (FIG. 1), for example, according to airtime access scheme 300, e.g., as described below.

In some demonstrative embodiments, as shown in FIG. 3, device 102 (FIG. 1) may maintain buffers of DL traffic for a device 340 (IRE2 client), which may be associated with three STA, e.g., a first STA 342, a second STA 344, and a third STA 346, each having a full buffer queue of DL traffic to be communicated from device 102 (FIG. 1). For example, device 140 (FIG. 1) may operate as and/or perform one or more functionalities of device 340.

In some demonstrative embodiments, as shown in FIG. 3, device 102 (FIG. 1) may also maintain a buffer of DL traffic for a device 360 (Client 3.1.1), which may be associated with device 102 (FIG. 1), and may have a full buffer queue. For example, device 160 (FIG. 1) may operate as and/or perform one or more functionalities of device 360.

In some demonstrative embodiments, as shown in FIG. 3, device 102 (FIG. 1) may assign device 360 with a weight of ¼, and/or each of the STA associated with device 340 with a weight of ¼.

In some demonstrative embodiments, as shown in FIG. 3, device 102 (FIG. 1) may allocate a first time period 361 for a TxOP for device 360TxOP, and a second time period 341 for a TxOP for device 340.

In some demonstrative embodiments, as shown in FIG. 3, first time period 361 and second time period 341 may be proportional to the number of STA which may be served by device 102 (FIG. 1), e.g., second time period 341 may be three times longer than first time period 361.

In some demonstrative embodiments, if a STA, e.g., STA 342, does not need all of the duration of the TxOP, e.g., if there is not enough throughput to the STA, the STA may release the TxOP before an end of the TxOP.

In some demonstrative embodiments, achieving a full fairness in scheme 300 may be difficult, e.g., even if STAs release the TxOP before the end.

In one example, device 340 may be associated with only two STAs, e.g., STA 342 and 344. According to this example, if STA 342 has full buffer and STA 344 has only a low throughout, a time period for the TxOP for STA 344 may reflect a single user TxOP, which may result in providing to STA 344 a capacity, which may be larger than needed.

Referring back to FIG. 1, the first fairness mechanism, e.g., airtime access scheme 300 (FIG. 3), may not be optimal in some cases and/or scenarios, e.g., if one or more STAs are inactive and/or have reduced throughput needs, e.g., as described above.

In some demonstrative embodiments, device 102 may implement a second fairness mechanism, which may be suitable, for example, at least for a scenario, in which the amount of data pending for every STA may be different, e.g., as described below.

In some demonstrative embodiments, the second fairness mechanism may determine one or more channel access parameters, e.g., EDCA parameters, for each STA having traffic pending transmission at device 102, and may dynamically adjust the channel access parameters, for example, based at least on the throughput pending transmission for each STA.

In some demonstrative embodiments, device 102 may be configured to determine a TxOP duration for a STA, e.g., for each STA, associated with device 102, e.g., as described below.

In some demonstrative embodiments, other STAs may not be allowed to use the TxOP duration for the STA, e.g., even if the STA does not need the whole TxOP duration.

In some demonstrative embodiments, device 102 may be configured to calculate a TxOP duration for each STA, for example, based on the pending throughput for the STA, e.g., as describes below.

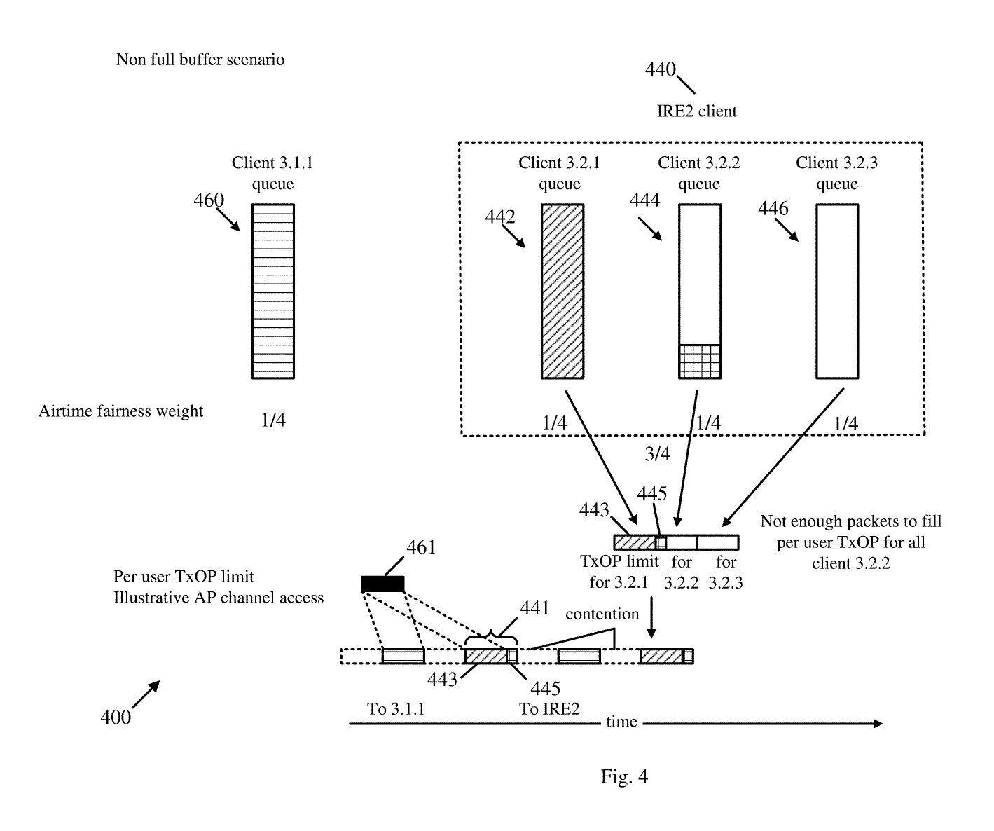

Reference is made to FIG. 4, which schematically illustrates an airtime access scheme 400, in accordance with some demonstrative embodiments.

In some demonstrative embodiments, airtime access scheme 400 may be configured to support, for example, even a non-full buffer scenario, in which an amount of data pending for every STA may be different.

In some demonstrative embodiments, device 102 (FIG. 1) may allocate one or more communication resources, for example, a TxOP parameter, e.g., a max TxOP limit, to devices 140 and 160 (FIG. 1), for example, according to airtime access scheme 400, e.g., as described below.

In some demonstrative embodiments, as shown in FIG. 4, device 102 (FIG. 1) may maintain buffers of DL traffic for a device 440 (IRE2 client), which may be associated with three STA, e.g., a first STA 442, a second STA 444, and a third STA 446. For example, device 140 (FIG. 1) may operate as and/or perform one or more functionalities of device 340.

In some demonstrative embodiments, as shown in FIG. 4, STA 442 may have a full buffer, STA 444 may have a partial buffer, and/or STA 446 may not have any DL data pending for transmission at device 102 (FIG. 1).

In some demonstrative embodiments, as shown in FIG. 4, device 102 (FIG. 1) may also maintain a buffer of DL traffic for a device 460 (Client 3.1.1), which may be associated with device 102 (FIG. 1), and may have a full buffer queue. For example, device 160 (FIG. 1) may operate as and/or perform one or more functionalities of device 460.

In some demonstrative embodiments, as shown in FIG. 4, device 102 (FIG. 1) may assign device 460 with a weight of ¼, and/or each of the STA associated with device 440 with a weight of ¼.

In some demonstrative embodiments, as shown in FIG. 4, device 102 (FIG. 1) may allocate a first time period 461 to device 460 for a TxOP, and a second time period 441 to device 440 for a TxOP.

In some demonstrative embodiments, as shown in FIG. 4, the durations of first time period 461 and second time period 441 may be proportional to the amount of traffic pending transmission for devices 460, 442, 444, and 446.

For example, first time period 461 may include a TxOP duration, which corresponds to a full single user TxOP duration, e.g., when device 460 has a full buffer of traffic pending transmission.

For example, second time period 441 may include a first TxOP duration 443, which corresponds to a full single user TxOP duration, e.g., when STA 442 has a full buffer of traffic pending transmission, and a second TxOP duration 445, which may correspond to a partial single user TxOP duration, e.g., when STA 444 has a partial buffer of traffic pending transmission.

In some demonstrative embodiments, for example, device 102 (FIG. 1) may be configured to calculate first time period 461 and second time period 441, e.g., based on information of queues of STA 460 and STAs 442, 444, and/or 446.

In some demonstrative embodiments, when device 102 (FIG. 1) is to schedule DL traffic to STA 440, device 102 (FIG. 1) may check an amount of traffic pending for transmission for STAs 442, 444 and 446, and to determine a TxOP duration for each STA of STAs 442, 444 and 446, for example, based on the amount of traffic pending for transmission for each STA. For example, device 102 (FIG. 1) may to determine a TxOP duration for STA 440, e.g., second time period 441, for example, as the total of the TxOP durations of each of the STAs, e.g., as the sum of TxOP duration 445+TxOP duration 443.

Referring back to FIG. 1, in some demonstrative embodiments, devices 102, 140 and/or 160 may be configured to perform multi user (MU) DL communication, e.g., in accordance with an IEEE 802.11ax Specification, and/or any other MU communication scheme.

In some demonstrative embodiments, the multi-user communication may be possible in DL communication, for example, by an AP, which may access a wireless channel and may transmit a single frame, e.g., a Physical Layer (PHY) Protocol Data Unit (PPDU), to multiple STAs/clients, for example, by sharing communication resources between the STAs, for example, in a time-domain, as well as in a frequency-domain and/or a space-domain. According to these embodiments, airtime fairness may be achieved, for example, by exploiting resource unit allocations, e.g., in the frequency-domain, for example, using OFDMA, and/or spatial streams allocation, e.g., in the space-domain, for example, using MU-MIMO.

In one example, the airtime fairness may be achieved, for example, by sharing frequency-domain and/or space-domain resources between STAs in a proportional manner. However, while an allocation limit of a resource in the time-domain per STA, e.g., a TxOP duration per STA, may be released if the resources are not used, resources allocated in the frequency-domain and/or space-domain may not be released. For example, if a communication resource in the frequency-domain and/or space-domain is not used by a STA, the other STAs may not be able to use the same communication resource. Therefore, in some embodiments, one suitable approach may be to use time-domain resources, e.g., a TxOP duration, for airtime fairness, and, optionally, to use the time-domain resources in combination with frequency-domain and/or space-domain resources.

In some demonstrative embodiments, devices 102, 140 and 160, may be configured to perform uplink communication, for example, from the wireless communication stations 170 to device 102, e.g., over the backhaul link 145 via device 140, and/or from device 160 to device 102, e.g., over link 145, e.g., as described below.

In some demonstrative embodiments, controller 124 may be configured to control, cause and/or trigger device 102 to determine one or more channel access parameters to include one or more backhaul uplink channel access parameters to allocate one or more communication resources for uplink communication from the wireless communication stations 170 to device 102 over the backhaul link 145, e.g., as described below.

In some demonstrative embodiments, controller 124 may be configured to control, cause and/or trigger device 102 to send to device 140 a message including the one or more backhaul uplink channel access parameters, e.g., as described below.

In some demonstrative embodiments, devices 102, 140 and/or 160 may apply airtime fairness for the uplink communication using one or more mechanisms similar to the fairness mechanisms described above with respect to the DL communication, for example, by determining channel access parameters, e.g., a TxOP duration, for a STA which is proportional to a count of users associated with the STA and/or to an amount of traffic pending transmission for the STA, e.g., as described above.

In some demonstrative embodiments, an implementation of the airtime fairness for UL communication may be different than the implementations discussed above with respect to DL communication, e.g., at least in the sense that one or more operations may not be performed by device 102, e.g., in a MAC EDCA of device 102, but distributed between STAs associated with device 102, e.g., STA 160, and associated with device 140, e.g., the wireless communication stations 170.

In some demonstrative embodiments, an AP, e.g., an AP implemented by device 102, may indicate the channel access parameters allocated for UL, e.g., over links 145 and/or 149, for example, by including one or more information elements in beacons transmitted by device 102, e.g., in a EDCA parameter set element. However, the channel access parameters indicated by beacons may not be changed to include, for example, different channel access parameters for different STA, and all the STA may receive the same channel access parameters. Accordingly, in some embodiments, one or more modifications may be applied, e.g., as described below.

In some demonstrative embodiments, a STA associated with device 102, e.g., device 160, may be instructed to accesses a wireless channel with a TxOP duration of a single STA. For example, device 102 may set a TxOP limit in an EDCA parameter set element to a TxOP duration of a single STA.

In some demonstrative embodiments, a relay station, e.g., device 140, may access the wireless channel with a TxOP duration which may be based on a count of STAs, e.g., stations 170, to be relayed by device 140 to device 102, e.g., as described above.

In some demonstrative embodiments, the relay station may be configured to access the wireless channel with the TxOP duration of multiple STAs, for example, although the relay station may receive in the EDCA parameter set element the TxOP limit including a TxOP duration of a single STA. For example, the relay station, e.g., device 140, may be configured to calculate an actual TxOP duration, for example, based on the TxOP duration of the single STA and queues of STAs associated with the relay STA, e.g., stations 170, that may use UL backhaul 145 to device 102, e.g., according to the airtime fairness mechanisms described above.

In some demonstrative embodiments, this mechanism may be predefined, e.g., may be defined in a specification, and/or one or more management/control frames may be directed from an AP to the relay station, e.g., from device 102 to device 140, to enable the relay station client to access the wireless channel with the TxOP duration of multiple STAs. In one example, a capability exchange over the air may be performed.

In some demonstrative embodiments, devices 102, 140 and/or 160 may be configured to perform multi-user UL communication, e.g., in accordance with an IEEE 802.11ax Specification and/or according to any other MU scheme.

In some demonstrative embodiments, the multi-user UL communication may be performed, for example, by an AP, which may access the wireless channel and may trigger a transmission of multiple PPDUs from multiple STAs/clients simultaneously, for example, by sharing communication resources between the multiple STAs/clients, e.g., in the time-domain as well as in the frequency-domain and/or the space-domain.

In some demonstrative embodiments, one or more aspects may be exploited, for example, when considering airtime fairness in UL MU communication e.g., as described below.

In some demonstrative embodiments, multiplexing of users in the frequency-domain and/or the space-domain, e.g., in addition to the time domain, may offer more degrees of freedom, for example, to share communication resources between users, to achieve the airtime fairness, e.g., similar to the DL MU communication.

In some demonstrative embodiments, an AP, e.g., an AP implemented by device 102, may be responsible for accessing the channel for a STA. Therefore, airtime fairness between the different STAs may be fully handled by the AP, for example, using the mechanisms described above for DL communication, e.g., instead of handling the airtime fairness in a distributed manner.

In one example, device 102 may be responsible for UL airtime fairness for device 140, and may have knowledge with respect to traffic pending transmission from stations 170, e.g., instead of or in addition to device 140, which may be responsible for UL airtime fairness in the distributed manner.

In one example, device 102 may be aware of traffic pending transmission from STAs 170. According to this example, a mechanism may be configured to enable device 102 to be aware of the traffic pending transmission from STAs 170. For example, a feedback in higher layers may be defined and/or a buffer status report may be configured, for example, to enable device 102 to receive from device 140 information with respect to traffic pending transmission from STAs 170.

In one example, a buffer status report may be configured, for example, to support queues of a client/STA, as well as multiple queues of different STAs associated with a relay station.

In some demonstrative embodiments, coordination between devices 102 and 140 may be performed, for example, using any suitable interface, for example, to allow device 102 to receive from device 140 information with respect to traffic pending transmission from STAs 170 to device 102 via relay 140.

In some demonstrative embodiments, device 102 may be aware of the a count of STAs associated with device 140, for example, to determine a channel access parameter for a single STA, e.g., a TxOP limit for a single STA, which may be used to determine a proportional channel access parameters for the associated STAs.

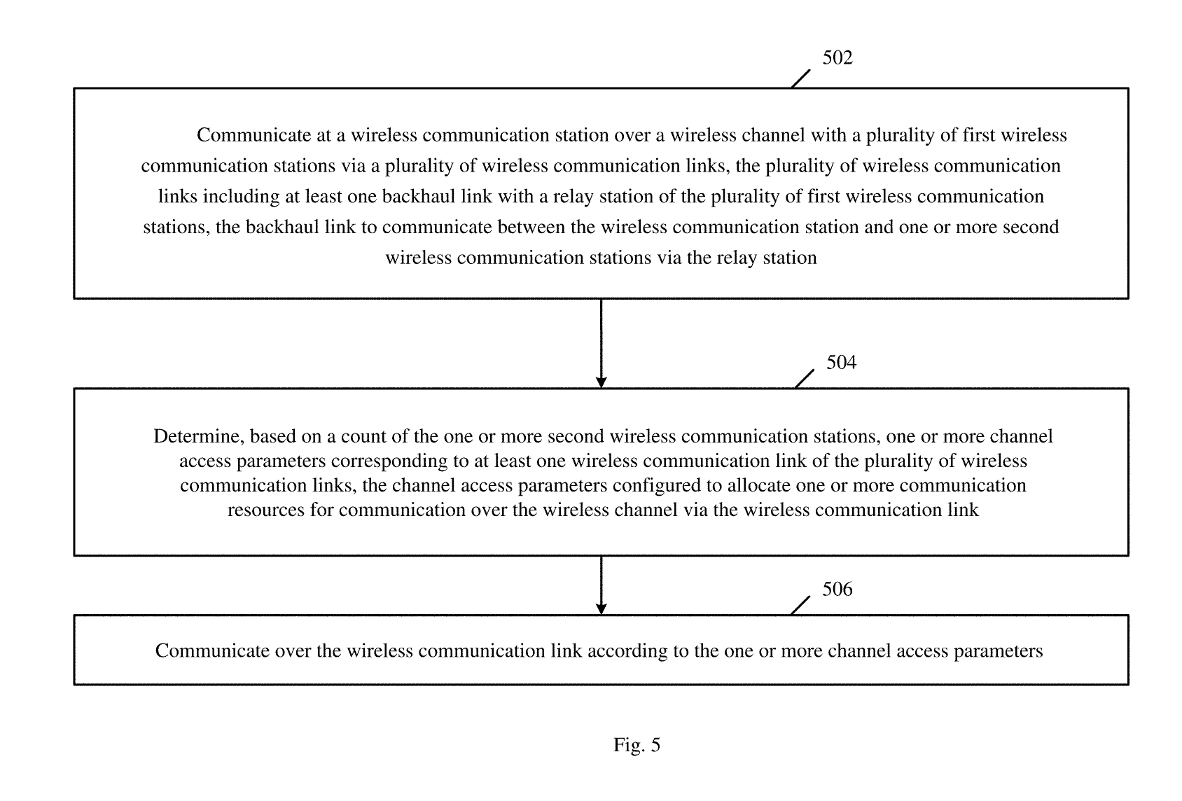

Reference is made to FIG. 5, which schematically illustrates a method of determining one or more channel access parameters, in accordance with some demonstrative embodiments. For example, one or more of the operations of the method of FIG. 5 may be performed by one or more elements of a system, e.g., system 100 (FIG. 1), for example, one or more wireless devices, e.g., device 102 (FIG. 1); a controller, e.g., controller 124 (FIG. 1); a radio, e.g., radio 114 (FIG. 1); a transmitter, e.g., transmitter 118 (FIG. 1); a receiver, e.g., receiver 116 (FIG. 1); and/or a message processor, e.g., message processor 128 (FIG. 1).

As indicated at block 502, the method may include communicating over a wireless channel with a plurality of first wireless communication stations via a plurality of wireless communication links, the plurality of wireless communication links including at least one backhaul link with a relay station of the plurality of first wireless communication stations, the backhaul link to communicate between the wireless communication station and one or more second wireless communication stations via the relay station. For example, controller 124 (FIG. 1) may control, cause, and/or trigger device 102 (FIG. 1) to communicate over the wireless channel with the plurality of first wireless communication stations 130 (FIG. 1) via the plurality of wireless communication links including the backhaul link 145 (FIG. 1) with device 140 (FIG. 1), e.g., to communicate between the wireless device 102 and STAs 170 (FIG. 1) via device 140 (FIG. 1), e.g., as described above.

As indicated at block 504, the method may include determining, based on a count of the one or more second wireless communication stations, one or more channel access parameters corresponding to at least one wireless communication link of the plurality of wireless communication links, the channel access parameters configured to allocate one or more communication resources for communication over the wireless channel via the wireless communication link. For example, controller 124 (FIG. 1) may control, cause, and/or trigger device 102 (FIG. 1) to determine the one or more channel access parameters corresponding to links 145 and/or 149 (FIG. 1), for example, based on the count of STAs 170 (FIG. 1), e.g., as described above.

As indicated at block 506, the method may include communicating over the wireless communication link according to the one or more channel access parameters. For example, controller 124 (FIG. 1) may control, cause, and/or trigger device 102 (FIG. 1) to communicating over the wireless communication links 145 and/or 149 (FIG. 1) according to the one or more channel access parameters, e.g., as described above.

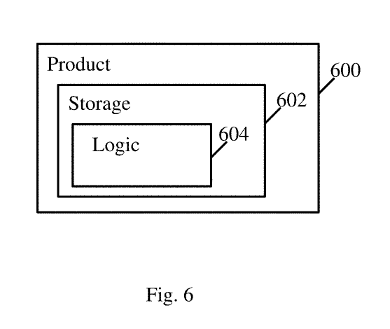

Reference is made to FIG. 6, which schematically illustrates a product of manufacture 600, in accordance with some demonstrative embodiments. Product 600 may include one or more tangible computer-readable (“machine readable”) non-transitory storage media 602, which may include computer-executable instructions, e.g., implemented by logic 604, operable to, when executed by at least one computer processor, enable the at least one computer processor to implement one or more operations at device 102 (FIG. 1), radio 114 (FIG. 1), transmitter 118 (FIG. 1), receiver 116 (FIG. 1), controller 124 (FIG. 1), and/or message processor 128 (FIG. 1), to cause device 102 (FIG. 1), radio 114 (FIG. 1), transmitter 118 (FIG. 1), receiver 116 (FIG. 1), 1), controller 124 (FIG. 1), and/or message processor 128 (FIG. 1), to perform one or more operations, and/or to perform, trigger and/or implement one or more operations, communications and/or functionalities described above with reference to FIGS. 1, 2, 3, 4, and/or 5, and/or one or more operations described herein. The phrases “non-transitory machine-readable medium” and “non-transitory computer-readable medium” are directed to include all machine-readable and/or computer-readable media, with the sole exception being a transitory propagating signal.

In some demonstrative embodiments, product 600 and/or storage media 602 may include one or more types of computer-readable storage media capable of storing data, including volatile memory, non-volatile memory, removable or non-removable memory, erasable or non-erasable memory, writeable or re-writeable memory, and the like. For example, storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further embodiments.

Example 1 includes an apparatus comprising logic and circuitry configured to cause a wireless communication station to communicate over a wireless channel with a plurality of first wireless communication stations via a plurality of wireless communication links, the plurality of wireless communication links comprising at least one backhaul link with a relay station of the plurality of first wireless communication stations, the backhaul link to communicate between the wireless communication station and one or more second wireless communication stations via the relay station; determine, based on a count of the one or more second wireless communication stations, one or more channel access parameters corresponding to at least one wireless communication link of the plurality of wireless communication links, the channel access parameters configured to allocate one or more communication resources for communication over the wireless channel via the wireless communication link; and communicate over the wireless communication link according to the one or more channel access parameters.

Example 2 includes the subject matter of Example 1, and optionally, wherein the apparatus is configured to cause the wireless communication station to determine a plurality of weight values corresponding to respective ones of the plurality of wireless communication links, and to determine the channel access parameters based on the plurality of weight values, a weight value corresponding to the backhaul link is based on the count of the one or more second wireless communication stations.

Example 3 includes the subject matter of Example 1 or 2, and optionally, wherein the apparatus is configured to cause the wireless communication station to determine the one or more channel access parameters to include one or more channel access parameters corresponding to the backhaul link based at least on the count of the one or more second wireless communication stations.

Example 4 includes the subject matter of Example 3, and optionally, wherein the apparatus is configured to cause the wireless communication station to determine the one or more channel access parameters corresponding to the backhaul link based at least on a throughput to be communicated with the one or more second wireless communication stations via the relay station.

Example 5 includes the subject matter of Example 4, and optionally, wherein the apparatus is configured to cause the wireless communication station to determine the one or more channel access parameters corresponding to the backhaul link based at least on a reference throughput for the one or more second wireless communication stations via the relay station.

Example 6 includes the subject matter of any one of Examples 1-5, and optionally, wherein the apparatus is configured to cause the wireless communication station to determine the one or more channel access parameters corresponding to the wireless communication link based at least on a first value and a second value, the first value based at least on a count of stations to be communicated via the wireless communication link, and the second value based at least on a total count of stations to be communicated via the plurality of wireless communication links.

Example 7 includes the subject matter of Example 6, and optionally, wherein the first value is based on a first throughput to be communicated over the wireless communication link, and the second value is based on a total throughput to be communicated via the plurality of wireless communication links.

Example 8 includes the subject matter of Example 6 or 7, and optionally, wherein the apparatus is configured to cause the wireless communication station to determine the one or more channel access parameters corresponding to the wireless communication link based on a ratio between the first value and the second value.

Example 9 includes the subject matter of any one of Examples 1-8, and optionally, wherein the backhaul link comprises a first backhaul link between the wireless communication station and a first relay station, the one or more second wireless communication stations comprising a second relay station and one or more third wireless communication stations to communicate with the wireless communication station via a second backhaul link between the first relay station and the second relay station.

Example 10 includes the subject matter of Example 9, and optionally, wherein the apparatus is configured to cause the wireless communication station to determine the one or more channel access parameters corresponding to the at least one wireless communication link based on a count of the one or more third wireless communication stations.

Example 11 includes the subject matter of any one of Examples 1-10, and optionally, wherein the apparatus is configured to cause the wireless communication station to receive from the relay station relay information to indicate the count of the one or more second wireless communication stations.

Example 12 includes the subject matter of any one of Examples 1-11, and optionally, wherein the apparatus is configured to cause the wireless communication station to determine the one or more channel access parameters to include one or more backhaul downlink channel access parameters to allocate one or more communication resources for downlink communication from the wireless communication station to the one or more second wireless communication stations over the backhaul link.

Example 13 includes the subject matter of Example 12, and optionally, wherein the apparatus is configured to cause the wireless communication station to determine the one or more backhaul downlink channel access parameters based on a total amount of traffic pending transmission to the one or more second wireless communication stations over the backhaul link.

Example 14 includes the subject matter of any one of Examples 1-13, and optionally, wherein the apparatus is configured to cause the wireless communication station to determine the one or more channel access parameters to include one or more backhaul uplink channel access parameters to allocate one or more communication resources for uplink communication from the one or more second wireless communication stations to the wireless communication station over the backhaul link, and to send to the relay station a message including the one or more backhaul uplink channel access parameters.

Example 15 includes the subject matter of any one of Examples 1-14, and optionally, wherein the apparatus is configured to cause the wireless communication station to adjust the one or more channel access parameters based on a change in the count of the one or more second wireless communication stations.

Example 16 includes the subject matter of any one of Examples 1-15, and optionally, wherein the one or more channel access parameters comprise one or more Enhanced Distributed Channel Access (EDCA) parameters.

Example 17 includes the subject matter of any one of Examples 1-16, and optionally, wherein the one or more channel access parameters comprise one or more parameters selected from the group consisting of a minimum Contention window (CWmin) parameter, a maximum Contention window (CWmax) parameter, an Arbitration Inter-Frame Spacing Number (AIFSN) parameter, and a transmission opportunity (TxOP) parameter.

Example 18 includes the subject matter of any one of Examples 1-17, and optionally, wherein the one or more communication resources comprise one or more time resources.

Example 19 includes the subject matter of any one of Examples 1-18, and optionally, wherein the one or more communication resources comprise one or more resource unit allocations in a frequency domain.

Example 20 includes the subject matter of any one of Examples 1-19, and optionally, wherein the one or more communication resources comprise one or more spatial stream allocations in a spatial-domain.

Example 21 includes the subject matter of any one of Examples 1-20, and optionally, wherein the backhaul link comprises at least one of an uplink (UL) backhaul link, or a downlink (DL) backhaul link.

Example 22 includes the subject matter of any one of Examples 1-21, and optionally, comprising a radio.

Example 23 includes the subject matter of any one of Examples 1-22, and optionally, comprising one or more antennas, a memory, and a processor.

Example 24 includes a system of wireless communication comprising a wireless communication station, the wireless communication station comprising one or more antennas; a radio; a memory; a processor; and a controller configured to cause the wireless communication station to communicate over a wireless channel with a plurality of first wireless communication stations via a plurality of wireless communication links, the plurality of wireless communication links comprising at least one backhaul link with a relay station of the plurality of first wireless communication stations, the backhaul link to communicate between the wireless communication station and one or more second wireless communication stations via the relay station; determine, based on a count of the one or more second wireless communication stations, one or more channel access parameters corresponding to at least one wireless communication link of the plurality of wireless communication links, the channel access parameters configured to allocate one or more communication resources for communication over the wireless channel via the wireless communication link; and communicate over the wireless communication link according to the one or more channel access parameters.

Example 25 includes the subject matter of Example 24, and optionally, wherein the controller is configured to cause the wireless communication station to determine a plurality of weight values corresponding to respective ones of the plurality of wireless communication links, and to determine the channel access parameters based on the plurality of weight values, a weight value corresponding to the backhaul link is based on the count of the one or more second wireless communication stations.

Example 26 includes the subject matter of Example 24 or 25, and optionally, wherein the controller is configured to cause the wireless communication station to determine the one or more channel access parameters to include one or more channel access parameters corresponding to the backhaul link based at least on the count of the one or more second wireless communication stations.

Example 27 includes the subject matter of Example 26, and optionally, wherein the controller is configured to cause the wireless communication station to determine the one or more channel access parameters corresponding to the backhaul link based at least on a throughput to be communicated with the one or more second wireless communication stations via the relay station.

Example 28 includes the subject matter of Example 27, and optionally, wherein the controller is configured to cause the wireless communication station to determine the one or more channel access parameters corresponding to the backhaul link based at least on a reference throughput for the one or more second wireless communication stations via the relay station.

Example 29 includes the subject matter of any one of Examples 24-28, and optionally, wherein the controller is configured to cause the wireless communication station to determine the one or more channel access parameters corresponding to the wireless communication link based at least on a first value and a second value, the first value based at least on a count of stations to be communicated via the wireless communication link, and the second value based at least on a total count of stations to be communicated via the plurality of wireless communication links.

Example 30 includes the subject matter of Example 29, and optionally, wherein the first value is based on a first throughput to be communicated over the wireless communication link, and the second value is based on a total throughput to be communicated via the plurality of wireless communication links.

Example 31 includes the subject matter of Example 29 or 30, and optionally, wherein the controller is configured to cause the wireless communication station to determine the one or more channel access parameters corresponding to the wireless communication link based on a ratio between the first value and the second value.

Example 32 includes the subject matter of any one of Examples 24-31, and optionally, wherein the backhaul link comprises a first backhaul link between the wireless communication station and a first relay station, the one or more second wireless communication stations comprising a second relay station and one or more third wireless communication stations to communicate with the wireless communication station via a second backhaul link between the first relay station and the second relay station.

Example 33 includes the subject matter of Example 32, and optionally, wherein the controller is configured to cause the wireless communication station to determine the one or more channel access parameters corresponding to the at least one wireless communication link based on a count of the one or more third wireless communication stations.

Example 34 includes the subject matter of any one of Examples 24-33, and optionally, wherein the controller is configured to cause the wireless communication station to receive from the relay station relay information to indicate the count of the one or more second wireless communication stations.

Example 35 includes the subject matter of any one of Examples 24-34, and optionally, wherein the controller is configured to cause the wireless communication station to determine the one or more channel access parameters to include one or more backhaul downlink channel access parameters to allocate one or more communication resources for downlink communication from the wireless communication station to the one or more second wireless communication stations over the backhaul link.

Example 36 includes the subject matter of Example 35, and optionally, wherein the controller is configured to cause the wireless communication station to determine the one or more backhaul downlink channel access parameters based on a total amount of traffic pending transmission to the one or more second wireless communication stations over the backhaul link.

Example 37 includes the subject matter of any one of Examples 24-36, and optionally, wherein the controller is configured to cause the wireless communication station to determine the one or more channel access parameters to include one or more backhaul uplink channel access parameters to allocate one or more communication resources for uplink communication from the one or more second wireless communication stations to the wireless communication station over the backhaul link, and to send to the relay station a message including the one or more backhaul uplink channel access parameters.

Example 38 includes the subject matter of any one of Examples 24-37, and optionally, wherein the controller is configured to cause the wireless communication station to adjust the one or more channel access parameters based on a change in the count of the one or more second wireless communication stations.

Example 39 includes the subject matter of any one of Examples 24-38, and optionally, wherein the one or more channel access parameters comprise one or more Enhanced Distributed Channel Access (EDCA) parameters.

Example 40 includes the subject matter of any one of Examples 24-39, and optionally, wherein the one or more channel access parameters comprise one or more parameters selected from the group consisting of a minimum Contention window (CWmin) parameter, a maximum Contention window (CWmax) parameter, an Arbitration Inter-Frame Spacing Number (AIFSN) parameter, and a transmission opportunity (TxOP) parameter.

Example 41 includes the subject matter of any one of Examples 24-40, and optionally, wherein the one or more communication resources comprise one or more time resources.

Example 42 includes the subject matter of any one of Examples 24-41, and optionally, wherein the one or more communication resources comprise one or more resource unit allocations in a frequency domain.

Example 43 includes the subject matter of any one of Examples 24-42, and optionally, wherein the one or more communication resources comprise one or more spatial stream allocations in a spatial-domain.

Example 44 includes the subject matter of any one of Examples 24-43, and optionally, wherein the backhaul link comprises at least one of an uplink (UL) backhaul link, or a downlink (DL) backhaul link.

Example 45 includes a method to be performed at a wireless communication station, the method comprising communicating over a wireless channel with a plurality of first wireless communication stations via a plurality of wireless communication links, the plurality of wireless communication links comprising at least one backhaul link with a relay station of the plurality of first wireless communication stations, the backhaul link to communicate between the wireless communication station and one or more second wireless communication stations via the relay station; determining, based on a count of the one or more second wireless communication stations, one or more channel access parameters corresponding to at least one wireless communication link of the plurality of wireless communication links, the channel access parameters configured to allocate one or more communication resources for communication over the wireless channel via the wireless communication link; and communicating over the wireless communication link according to the one or more channel access parameters.

Example 46 includes the subject matter of Example 45, and optionally, comprising determining a plurality of weight values corresponding to respective ones of the plurality of wireless communication links, and determining the channel access parameters based on the plurality of weight values, a weight value corresponding to the backhaul link is based on the count of the one or more second wireless communication stations.

Example 47 includes the subject matter of Example 45 or 46, and optionally, comprising determining the one or more channel access parameters to include one or more channel access parameters corresponding to the backhaul link based at least on the count of the one or more second wireless communication stations.

Example 48 includes the subject matter of Example 47, and optionally, comprising determining the one or more channel access parameters corresponding to the backhaul link based at least on a throughput to be communicated with the one or more second wireless communication stations via the relay station.

Example 49 includes the subject matter of Example 48, and optionally, comprising determining the one or more channel access parameters corresponding to the backhaul link based at least on a reference throughput for the one or more second wireless communication stations via the relay station.

Example 50 includes the subject matter of any one of Examples 45-49, and optionally, comprising determining the one or more channel access parameters corresponding to the wireless communication link based at least on a first value and a second value, the first value based at least on a count of stations to be communicated via the wireless communication link, and the second value based at least on a total count of stations to be communicated via the plurality of wireless communication links.

Example 51 includes the subject matter of Example 50, and optionally, wherein the first value is based on a first throughput to be communicated over the wireless communication link, and the second value is based on a total throughput to be communicated via the plurality of wireless communication links.

Example 52 includes the subject matter of Example 50 or 51, and optionally, comprising determining the one or more channel access parameters corresponding to the wireless communication link based on a ratio between the first value and the second value.

Example 53 includes the subject matter of any one of Examples 45-52, and optionally, wherein the backhaul link comprises a first backhaul link between the wireless communication station and a first relay station, the one or more second wireless communication stations comprising a second relay station and one or more third wireless communication stations to communicate with the wireless communication station via a second backhaul link between the first relay station and the second relay station.

Example 54 includes the subject matter of Example 53, and optionally, comprising determining the one or more channel access parameters corresponding to the at least one wireless communication link based on a count of the one or more third wireless communication stations.

Example 55 includes the subject matter of any one of Examples 45-54, and optionally, comprising receiving from the relay station relay information to indicate the count of the one or more second wireless communication stations.

Example 56 includes the subject matter of any one of Examples 45-55, and optionally, comprising determining the one or more channel access parameters to include one or more backhaul downlink channel access parameters to allocate one or more communication resources for downlink communication from the wireless communication station to the one or more second wireless communication stations over the backhaul link.

Example 57 includes the subject matter of Example 56, and optionally, comprising determining the one or more backhaul downlink channel access parameters based on a total amount of traffic pending transmission to the one or more second wireless communication stations over the backhaul link.

Example 58 includes the subject matter of any one of Examples 45-57, and optionally, comprising determining the one or more channel access parameters to include one or more backhaul uplink channel access parameters to allocate one or more communication resources for uplink communication from the one or more second wireless communication stations to the wireless communication station over the backhaul link, and sending to the relay station a message including the one or more backhaul uplink channel access parameters.

Example 59 includes the subject matter of any one of Examples 45-58, and optionally, comprising adjusting the one or more channel access parameters based on a change in the count of the one or more second wireless communication stations.

Example 60 includes the subject matter of any one of Examples 45-59, and optionally, wherein the one or more channel access parameters comprise one or more Enhanced Distributed Channel Access (EDCA) parameters.

Example 61 includes the subject matter of any one of Examples 45-60, and optionally, wherein the one or more channel access parameters comprise one or more parameters selected from the group consisting of a minimum Contention window (CWmin) parameter, a maximum Contention window (CWmax) parameter, an Arbitration Inter-Frame Spacing Number (AIFSN) parameter, and a transmission opportunity (TxOP) parameter.

Example 62 includes the subject matter of any one of Examples 45-61, and optionally, wherein the one or more communication resources comprise one or more time resources.

Example 63 includes the subject matter of any one of Examples 45-62, and optionally, wherein the one or more communication resources comprise one or more resource unit allocations in a frequency domain.

Example 64 includes the subject matter of any one of Examples 45-63, and optionally, wherein the one or more communication resources comprise one or more spatial stream allocations in a spatial-domain.

Example 65 includes the subject matter of any one of Examples 45-64, and optionally, wherein the backhaul link comprises at least one of an uplink (UL) backhaul link, or a downlink (DL) backhaul link.

Example 66 includes a product comprising one or more tangible computer-readable non-transitory storage media comprising computer-executable instructions operable to, when executed by at least one processor, enable the at least one processor to cause a first wireless communication station to communicate over a wireless channel with a plurality of first wireless communication stations via a plurality of wireless communication links, the plurality of wireless communication links comprising at least one backhaul link with a relay station of the plurality of first wireless communication stations, the backhaul link to communicate between the wireless communication station and one or more second wireless communication stations via the relay station; determine, based on a count of the one or more second wireless communication stations, one or more channel access parameters corresponding to at least one wireless communication link of the plurality of wireless communication links, the channel access parameters configured to allocate one or more communication resources for communication over the wireless channel via the wireless communication link; and communicate over the wireless communication link according to the one or more channel access parameters.

Example 67 includes the subject matter of Example 66, and optionally, wherein the instructions, when executed, cause the wireless communication station to determine a plurality of weight values corresponding to respective ones of the plurality of wireless communication links, and to determine the channel access parameters based on the plurality of weight values, a weight value corresponding to the backhaul link is based on the count of the one or more second wireless communication stations.

Example 68 includes the subject matter of Example 66 or 67, and optionally, wherein the instructions, when executed, cause the wireless communication station to determine the one or more channel access parameters to include one or more channel access parameters corresponding to the backhaul link based at least on the count of the one or more second wireless communication stations.

Example 69 includes the subject matter of Example 68, and optionally, wherein the instructions, when executed, cause the wireless communication station to determine the one or more channel access parameters corresponding to the backhaul link based at least on a throughput to be communicated with the one or more second wireless communication stations via the relay station.

Example 70 includes the subject matter of Example 69, and optionally, wherein the instructions, when executed, cause the wireless communication station to determine the one or more channel access parameters corresponding to the backhaul link based at least on a reference throughput for the one or more second wireless communication stations via the relay station.

Example 71 includes the subject matter of any one of Examples 66-70, and optionally, wherein the instructions, when executed, cause the wireless communication station to determine the one or more channel access parameters corresponding to the wireless communication link based at least on a first value and a second value, the first value based at least on a count of stations to be communicated via the wireless communication link, and the second value based at least on a total count of stations to be communicated via the plurality of wireless communication links.

Example 72 includes the subject matter of Example 71, and optionally, wherein the first value is based on a first throughput to be communicated over the wireless communication link, and the second value is based on a total throughput to be communicated via the plurality of wireless communication links.

Example 73 includes the subject matter of Example 71 or 72, and optionally, wherein the instructions, when executed, cause the wireless communication station to determine the one or more channel access parameters corresponding to the wireless communication link based on a ratio between the first value and the second value.

Example 74 includes the subject matter of any one of Examples 66-73, and optionally, wherein the backhaul link comprises a first backhaul link between the wireless communication station and a first relay station, the one or more second wireless communication stations comprising a second relay station and one or more third wireless communication stations to communicate with the wireless communication station via a second backhaul link between the first relay station and the second relay station.

Example 75 includes the subject matter of Example 74, and optionally, wherein the instructions, when executed, cause the wireless communication station to determine the one or more channel access parameters corresponding to the at least one wireless communication link based on a count of the one or more third wireless communication stations.

Example 76 includes the subject matter of any one of Examples 66-75, and optionally, wherein the instructions, when executed, cause the wireless communication station to receive from the relay station relay information to indicate the count of the one or more second wireless communication stations.

Example 77 includes the subject matter of any one of Examples 66-76, and optionally, wherein the instructions, when executed, cause the wireless communication station to determine the one or more channel access parameters to include one or more backhaul downlink channel access parameters to allocate one or more communication resources for downlink communication from the wireless communication station to the one or more second wireless communication stations over the backhaul link.

Example 78 includes the subject matter of Example 77, and optionally, wherein the instructions, when executed, cause the wireless communication station to determine the one or more backhaul downlink channel access parameters based on a total amount of traffic pending transmission to the one or more second wireless communication stations over the backhaul link.

Example 79 includes the subject matter of any one of Examples 66-78, and optionally, wherein the instructions, when executed, cause the wireless communication station to determine the one or more channel access parameters to include one or more backhaul uplink channel access parameters to allocate one or more communication resources for uplink communication from the one or more second wireless communication stations to the wireless communication station over the backhaul link, and to send to the relay station a message including the one or more backhaul uplink channel access parameters.

Example 80 includes the subject matter of any one of Examples 66-79, and optionally, wherein the instructions, when executed, cause the wireless communication station to adjust the one or more channel access parameters based on a change in the count of the one or more second wireless communication stations.

Example 81 includes the subject matter of any one of Examples 66-80, and optionally, wherein the one or more channel access parameters comprise one or more Enhanced Distributed Channel Access (EDCA) parameters.

Example 82 includes the subject matter of any one of Examples 66-81, and optionally, wherein the one or more channel access parameters comprise one or more parameters selected from the group consisting of a minimum Contention window (CWmin) parameter, a maximum Contention window (CWmax) parameter, an Arbitration Inter-Frame Spacing Number (AIFSN) parameter, and a transmission opportunity (TxOP) parameter.

Example 83 includes the subject matter of any one of Examples 66-82, and optionally, wherein the one or more communication resources comprise one or more time resources.

Example 84 includes the subject matter of any one of Examples 66-83, and optionally, wherein the one or more communication resources comprise one or more resource unit allocations in a frequency domain.

Example 85 includes the subject matter of any one of Examples 66-84, and optionally, wherein the one or more communication resources comprise one or more spatial stream allocations in a spatial-domain.

Example 86 includes the subject matter of any one of Examples 66-85, and optionally, wherein the backhaul link comprises at least one of an uplink (UL) backhaul link, or a downlink (DL) backhaul link.

Example 87 includes an apparatus of wireless communication by a wireless communication station, the apparatus comprising means for communicating over a wireless channel with a plurality of first wireless communication stations via a plurality of wireless communication links, the plurality of wireless communication links comprising at least one backhaul link with a relay station of the plurality of first wireless communication stations, the backhaul link to communicate between the wireless communication station and one or more second wireless communication stations via the relay station; means for determining, based on a count of the one or more second wireless communication stations, one or more channel access parameters corresponding to at least one wireless communication link of the plurality of wireless communication links, the channel access parameters configured to allocate one or more communication resources for communication over the wireless channel via the wireless communication link; and means for communicating over the wireless communication link according to the one or more channel access parameters.

Example 88 includes the subject matter of Example 87, and optionally, comprising means for determining a plurality of weight values corresponding to respective ones of the plurality of wireless communication links, and determining the channel access parameters based on the plurality of weight values, a weight value corresponding to the backhaul link is based on the count of the one or more second wireless communication stations.

Example 89 includes the subject matter of Example 87 or 88, and optionally, comprising means for determining the one or more channel access parameters to include one or more channel access parameters corresponding to the backhaul link based at least on the count of the one or more second wireless communication stations.

Example 90 includes the subject matter of Example 89, and optionally, comprising means for determining the one or more channel access parameters corresponding to the backhaul link based at least on a throughput to be communicated with the one or more second wireless communication stations via the relay station.

Example 91 includes the subject matter of Example 90, and optionally, comprising means for determining the one or more channel access parameters corresponding to the backhaul link based at least on a reference throughput for the one or more second wireless communication stations via the relay station.

Example 92 includes the subject matter of any one of Examples 87-91, and optionally, comprising means for determining the one or more channel access parameters corresponding to the wireless communication link based at least on a first value and a second value, the first value based at least on a count of stations to be communicated via the wireless communication link, and the second value based at least on a total count of stations to be communicated via the plurality of wireless communication links.

Example 93 includes the subject matter of Example 92, and optionally, wherein the first value is based on a first throughput to be communicated over the wireless communication link, and the second value is based on a total throughput to be communicated via the plurality of wireless communication links.

Example 94 includes the subject matter of Example 92 or 93, and optionally, comprising means for determining the one or more channel access parameters corresponding to the wireless communication link based on a ratio between the first value and the second value.

Example 95 includes the subject matter of any one of Examples 87-94, and optionally, wherein the backhaul link comprises a first backhaul link between the wireless communication station and a first relay station, the one or more second wireless communication stations comprising a second relay station and one or more third wireless communication stations to communicate with the wireless communication station via a second backhaul link between the first relay station and the second relay station.

Example 96 includes the subject matter of Example 95, and optionally, comprising means for determining the one or more channel access parameters corresponding to the at least one wireless communication link based on a count of the one or more third wireless communication stations.

Example 97 includes the subject matter of any one of Examples 87-96, and optionally, comprising means for receiving from the relay station relay information to indicate the count of the one or more second wireless communication stations.

Example 98 includes the subject matter of any one of Examples 87-97, and optionally, comprising means for determining the one or more channel access parameters to include one or more backhaul downlink channel access parameters to allocate one or more communication resources for downlink communication from the wireless communication station to the one or more second wireless communication stations over the backhaul link.

Example 99 includes the subject matter of Example 98, and optionally, comprising means for determining the one or more backhaul downlink channel access parameters based on a total amount of traffic pending transmission to the one or more second wireless communication stations over the backhaul link.

Example 100 includes the subject matter of any one of Examples 87-99, and optionally, comprising means for determining the one or more channel access parameters to include one or more backhaul uplink channel access parameters to allocate one or more communication resources for uplink communication from the one or more second wireless communication stations to the wireless communication station over the backhaul link, and sending to the relay station a message including the one or more backhaul uplink channel access parameters.

Example 101 includes the subject matter of any one of Examples 87-100, and optionally, comprising means for adjusting the one or more channel access parameters based on a change in the count of the one or more second wireless communication stations.

Example 102 includes the subject matter of any one of Examples 87-101, and optionally, wherein the one or more channel access parameters comprise one or more Enhanced Distributed Channel Access (EDCA) parameters.

Example 103 includes the subject matter of any one of Examples 87-102, and optionally, wherein the one or more channel access parameters comprise one or more parameters selected from the group consisting of a minimum Contention window (CWmin) parameter, a maximum Contention window (CWmax) parameter, an Arbitration Inter-Frame Spacing Number (AIFSN) parameter, and a transmission opportunity (TxOP) parameter.

Example 104 includes the subject matter of any one of Examples 87-103, and optionally, wherein the one or more communication resources comprise one or more time resources.

Example 105 includes the subject matter of any one of Examples 87-104, and optionally, wherein the one or more communication resources comprise one or more resource unit allocations in a frequency domain.

Example 106 includes the subject matter of any one of Examples 87-105, and optionally, wherein the one or more communication resources comprise one or more spatial stream allocations in a spatial-domain.

Example 107 includes the subject matter of any one of Examples 87-106, and optionally, wherein the backhaul link comprises at least one of an uplink (UL) backhaul link, or a downlink (DL) backhaul link.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a wireless communication station to:
communicate over a wireless channel with a plurality of first wireless communication stations via a plurality of wireless communication links, the plurality of wireless communication links comprising at least one backhaul link with a relay station of the plurality of first wireless communication stations, the backhaul link to communicate between the wireless communication station and one or more second wireless communication stations via the relay station;
determine, based on a count of the one or more second wireless communication stations, one or more channel access parameters corresponding to at least one wireless communication link of the plurality of wireless communication links, the channel access parameters configured to allocate one or more communication resources for communication over the wireless channel via the wireless communication link; and
communicate over the wireless communication link according to the one or more channel access parameters.

2. The apparatus of claim 1 configured to cause the wireless communication station to determine a plurality of weight values corresponding to respective ones of the plurality of wireless communication links, and to determine the channel access parameters based on the plurality of weight values, a weight value corresponding to the backhaul link is based on the count of the one or more second wireless communication stations.

3. The apparatus of claim 1 configured to cause the wireless communication station to determine the one or more channel access parameters to include one or more channel access parameters corresponding to the backhaul link based at least on the count of the one or more second wireless communication stations.

4. The apparatus of claim 3 configured to cause the wireless communication station to determine the one or more channel access parameters corresponding to the backhaul link based at least on a throughput to be communicated with the one or more second wireless communication stations via the relay station.

5. The apparatus of claim 4 configured to cause the wireless communication station to determine the one or more channel access parameters corresponding to the backhaul link based at least on a reference throughput for the one or more second wireless communication stations via the relay station.

6. The apparatus of claim 1 configured to cause the wireless communication station to determine the one or more channel access parameters corresponding to the wireless communication link based at least on a first value and a second value, the first value based at least on a count of stations to be communicated via the wireless communication link, and the second value based at least on a total count of stations to be communicated via the plurality of wireless communication links.

7. The apparatus of claim 6, wherein the first value is based on a first throughput to be communicated over the wireless communication link, and the second value is based on a total throughput to be communicated via the plurality of wireless communication links.

8. The apparatus of claim 1, wherein the backhaul link comprises a first backhaul link between the wireless communication station and a first relay station, the one or more second wireless communication stations comprising a second relay station and one or more third wireless communication stations to communicate with the wireless communication station via a second backhaul link between the first relay station and the second relay station.

9. The apparatus of claim 8 configured to cause the wireless communication station to determine the one or more channel access parameters corresponding to the at least one wireless communication link based on a count of the one or more third wireless communication stations.

10. The apparatus of claim 1 configured to cause the wireless communication station to receive from the relay station relay information to indicate the count of the one or more second wireless communication stations.

11. The apparatus of claim 1 configured to cause the wireless communication station to determine the one or more channel access parameters to include one or more backhaul downlink channel access parameters to allocate one or more communication resources for downlink communication from the wireless communication station to the one or more second wireless communication stations over the backhaul link.

12. The apparatus of claim 1 configured to cause the wireless communication station to determine the one or more channel access parameters to include one or more backhaul uplink channel access parameters to allocate one or more communication resources for uplink communication from the one or more second wireless communication stations to the wireless communication station over the backhaul link, and to send to the relay station a message including the one or more backhaul uplink channel access parameters.

13. The apparatus of claim 1 configured to cause the wireless communication station to adjust the one or more channel access parameters based on a change in the count of the one or more second wireless communication stations.

14. The apparatus of claim 1, wherein the one or more channel access parameters comprise one or more Enhanced Distributed Channel Access (EDCA) parameters.

15. The apparatus of claim 1, wherein the one or more channel access parameters comprise one or more parameters selected from the group consisting of a minimum Contention window (CWmin) parameter, a maximum Contention window (CWmax) parameter, an Arbitration Inter-Frame Spacing Number (AIFSN) parameter, and a transmission opportunity (TxOP) parameter.

16. The apparatus of claim 1, wherein the one or more communication resources comprise one or more time resources.

17. The apparatus of claim 1, wherein the one or more communication resources comprise one or more resource unit allocations in a frequency domain.

18. The apparatus of claim 1 comprising one or more antennas, a memory, and a processor.

19. A method to be performed at a wireless communication station, the method comprising:
communicating over a wireless channel with a plurality of first wireless communication stations via a plurality of wireless communication links, the plurality of wireless communication links comprising at least one backhaul link with a relay station of the plurality of first wireless communication stations, the backhaul link to communicate between the wireless communication station and one or more second wireless communication stations via the relay station;
determining, based on a count of the one or more second wireless communication stations, one or more channel access parameters corresponding to at least one wireless communication link of the plurality of wireless communication links, the channel access parameters configured to allocate one or more communication resources for communication over the wireless channel via the wireless communication link; and
communicating over the wireless communication link according to the one or more channel access parameters.

20. The method of claim 19 comprising determining a plurality of weight values corresponding to respective ones of the plurality of wireless communication links, and determining the channel access parameters based on the plurality of weight values, a weight value corresponding to the backhaul link is based on the count of the one or more second wireless communication stations.

21. A product comprising one or more tangible computer-readable non-transitory storage media comprising computer-executable instructions operable to, when executed by at least one processor, enable the at least one processor to cause a wireless communication station to:
communicate over a wireless channel with a plurality of first wireless communication stations via a plurality of wireless communication links, the plurality of wireless communication links comprising at least one backhaul link with a relay station of the plurality of first wireless communication stations, the backhaul link to communicate between the wireless communication station and one or more second wireless communication stations via the relay station;
determine, based on a count of the one or more second wireless communication stations, one or more channel access parameters corresponding to at least one wireless communication link of the plurality of wireless communication links, the channel access parameters configured to allocate one or more communication resources for communication over the wireless channel via the wireless communication link; and
communicate over the wireless communication link according to the one or more channel access parameters.

22. The product of claim 21, wherein the instructions, when executed, cause the wireless communication station to determine a plurality of weight values corresponding to respective ones of the plurality of wireless communication links, and to determine the channel access parameters based on the plurality of weight values, a weight value corresponding to the backhaul link is based on the count of the one or more second wireless communication stations.

23. The product of claim 21, wherein the instructions, when executed, cause the wireless communication station to determine the one or more channel access parameters corresponding to the wireless communication link based at least on a first value and a second value, the first value based at least on a count of stations to be communicated via the wireless communication link, and the second value based at least on a total count of stations to be communicated via the plurality of wireless communication links.

24. The product of claim 21, wherein the backhaul link comprises a first backhaul link between the wireless communication station and a first relay station, the one or more second wireless communication stations comprising a second relay station and one or more third wireless communication stations to communicate with the wireless communication station via a second backhaul link between the first relay station and the second relay station.

25. The product of claim 24, wherein the instructions, when executed, cause the wireless communication station to determine the one or more channel access parameters corresponding to the at least one wireless communication link based on a count of the one or more third wireless communication stations.
